(19) United States
(12) Patent Application Publication
(10) Pub. No.: US 2002/0136686 A1
(43) Pub. Date: Sep. 26, 2002

(54) Catalyst and catalyst production method

(75) Inventor: Hiroaki Takahashi, Toyota-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/068,875

(22) Filed: Feb. 11, 2002

Related U.S. Application Data
(62) Division of application No. 09/510,529, filed on Feb. 22, 2000.

(30) Foreign Application Priority Data
Mar. 3, 1999 (JP) HEI 11-55946
Mar. 3, 1999 (JP) HEI 11-55943
Mar. 3, 1999 (JP) HEI 11-56131
Oct. 13, 1999 (JP) HEI 11-291119
Dec. 15, 1999 (JP) HEI 11-355873
Jan. 11, 2000 (JP) 2000-2259

(51) Int. Cl. C01B 3/26

(52) U.S. Cl. 423/651; 423/648.1

(57) ABSTRACT

By using a catalyst formed by carrying a noble metal such as platinum, palladium, rhodium, iridium, or ruthenium, and an element from the 2B and 3B families such as zinc, gallium, or indium, on a basic metal oxide carrier, such as cerium dioxide or zirconium dioxide, or a catalyst formed by carrying similar noble metal and an alkali metal, such as sodium, potassium, or cesium, or an alkaline earth metal such as magnesium, calcium, or barium on a similar carrier, methanol can be water vapor reformed with a high efficiency while the carbon monoxide concentration in the obtained hydrogen-containing gas can be simultaneously kept at a low level.

### BACKGROUND OF THE INVENTION

1. Field of the Invention

The present invention relates to catalysts and a catalyst production method and in particular, to catalysts used for reforming reaction of methanol to a hydrogen-containing gas using water vapor and a method for producing such catalysts.

2. Description of the Related Art

The water vapor reforming reaction of the methanol where the methanol is reformed to hydrogen-containing gas using water vapor is performed by a decomposition reaction represented by equation 1 and a shift reaction represented by equation 2.

CH₃OH→CO+2H₂ (1)

CO+H₂O→CO₂+H₂ (2)

As efficient catalysts facilitating these reactions, catalysts comprising a mixture of thermostable porous inorganic compound, a base metal or a noble metal, and an alkali metal or an alkaline-earth metal (such as disclosed in, for example, Japanese Patent Laid-Open Publication No. Sho 62-250948), and catalysts formed by carrying a noble metal on a carrier including oxides of rare earth elements (as, for example, in Japanese Patent Laid-Open Publication No. Hei 3-45501) are proposed. These catalysts solve the thermostability and durability problem inherent with the copper catalysts, which show high activity in the water vapor reforming reaction of ethanol.

However, in the above catalysts, the obtained hydrogen-containing gas may contain a high concentration of carbon monoxide. Because the reaction rate of the shift reaction represented by equation 2 is slow, the hydrogen-containing gas generally contains carbon monoxide. When methanol is water vapor reformed to obtain hydrogen-containing gas to be supplied to a device which operates using hydrogen as a fuel, it is advantageous to have a high concentration of hydrogen in hydrogen-containing gas and, therefore, to have a low concentration of unreacted carbon monoxide. Especially in cases where the efficiency of the device which receives the hydrogen-containing gas supply decreases with the carbon monoxide contained in the hydrogen-containing gas, such as, for example, where the device is a fuel cell which would be poisoned by the carbon monoxide contained in the hydrogen-containing gas, the carbon monoxide concentration must be kept low.

For the above catalysts formed by carrying a noble metal on a carrier containing oxides of the rare earth elements (such as in JP Laid-Open Publication No. Hei 3-45501), the catalysts are obtained by first immersing the carrier containing oxides of rare earth elements in a solution of an ammine chloride salt of noble metal, for example, tetraammine platinum chloride [Pt(NH₃)₄Cl₂], to carry the noble metal on the carrier, and then, after drying, calcinating it at 500° C. for 3 hours. Catalysts thus obtained does not have a high catalyst activity. In this catalyst production process, an ammine chloride salt of noble metal is used, and thus the resulting catalyst contains a small amount of chlorine. In the water vapor reforming reaction of the methanol, chlorine adsorbs to the noble metal acting as a catalyst and acts as a poison. Chlorine which enters the catalyst during the production process will also act as a poison and will impede the water vapor reforming reaction.

### SUMMARY OF THE INVENTION

One objective of the catalyst according to the present invention is to efficiently reform hydrocarbon fuel, especially methanol. Another objective of the catalyst according to the present invention is to decrease the concentration of carbon monoxide contained in the obtained hydrogen-containing gas. One objective of the production method of the catalyst according to the present invention is to produce catalysts which can efficiently reform hydrocarbon fuel, especially methanol, while simultaneously decreasing the concentration of carbon monoxide contained in the obtained hydrogen-containing gas. Another objective of the production method of the catalyst according to the present invention is to produce catalysts which do not contain any chlorine which can act as a poison. A still further objective of the production method of the catalyst according to the present invention is to produce catalysts carrying a noble metal instead of oxides of a noble metal.

In order to solve these objectives, the present invention employs the following.

A first catalyst according to the present invention is formed by carrying a noble metal and at least one element from the elements in the 2B and 3B family on a carrier formed from porous metal oxides.

In the first catalyst according to the present invention, the noble metal can act alone as a catalyst for reforming hydrocarbon fuel, especially methanol, but by using a porous metal oxide as a carrier and carrying at least one element from the 2B and 3B family with the noble metal, the hydrocarbon fuel, especially methanol, can be reformed with high efficiency and, at the same time, the concentration of carbon monoxide contained in the obtained hydrogen-containing gas can be decreased.

For the first catalyst according to the present invention, one noble metal from the group consisting of platinum, palladium, rhodium, iridium, and ruthenium can be used as the noble metal to be carried on the carrier. Among these, platinum and palladium are preferable. As the element from the 2B and 3B family to be carried on the carrier, any one of zinc, cadmium, mercury, aluminum, gallium, or indium can be used, but use of one of zinc, gallium, or indium is preferable. Furthermore, any porous metal oxide can be used as the carrier, but it is preferable to use a basic metal oxide, especially cerium dioxide (CeO₂), zirconium dioxide (ZrO₂), or tin dioxide (TiO₂). Among combinations of these, indium as the element from the 2B and 3B family, platinum as a noble metal, and zirconium dioxide (ZrO₂) as the porous metal oxide is particularly preferable.

A first production method of catalysts according to the present invention comprises the steps of (a) impregnating and carrying a noble metal on a porous metal oxide carrier, and (b) siphoning and carrying at least one element from the 2B and 3B family on said carrier carrying noble metal.

In the first production method of catalysts according to the present invention, a catalyst can be produced by first impregnating and carrying a noble metal on a porous metal oxide carrier and then siphoning and carrying at least one element from the 2B and 3B family on the carrier. The produced catalysts can reform hydrocarbon fuel, especially methanol with high efficiency and can reduce the concentration of carbon monoxide present in the hydrogen-containing gas.

In the first production method of catalysts according to the present invention, it is preferable to use cerium dioxide (CeO₂), zirconium dioxide (ZrO₂), or titanium dioxide (TiO₂) as the porous metal oxide carrier and to use platinum or palladium as the noble metal in step (a). In step (b), it is preferable to use zinc, gallium, or indium as the element from the 2B and 3B family.

A second catalyst according to the present invention is formed by first carrying at least one element from the alkali metal or alkaline earth metal family to a carrier formed from a porous metal oxide and then carrying a noble metal and at least one element from the 2B and 3B family on said carrier.

In the second catalyst of the present invention, the noble metal can act alone as a catalyst for reforming hydrocarbon fuel, especially methanol, but, by using a porous metal oxide as a carrier as well as carrying an element from the 2B and 3B family and an element from an alkali metal or an alkaline earth metal family with the noble metal, the hydrocarbon fuel, especially methanol, can be reformed with high efficiency while the concentration of carbon monoxide contained in the obtained hydrogen-containing gas is simultaneously reduced. Because an element from the alkali metal or alkaline earth metal family is carried first, the effects of the noble metal and an element from the 2B and 3B family are preserved.

For the second catalyst of the present invention, any one of platinum, palladium, rhodium, iridium, or ruthenium can be used as the noble metal to be carried in the carrier. Among these, platinum and palladium are preferable. As the element from the 2B and 3B family to be carried on the carrier, any one of zinc, cadmium, mercury, aluminum, gallium, or indium can be used, but it is preferable to use one of zinc, gallium, or indium. Furthermore, any porous metal oxide can be used as the carrier, but a basic metal oxide, especially cerium dioxide (CeO₂) or zirconium dioxide (ZrO₂), is preferable.

A second production method of catalysts according to the present invention comprises the steps of (a) carrying at least one element from the alkali metal or alkaline earth metal family on a carrier formed from porous metal oxide, and (b) carrying a noble metal and at least one element from the 2B and 3B family on said carrier carrying at least one element from the alkali metal or alkaline earth metal family.

In the second production method of catalysts according to the present invention, a catalyst can be produced by first carrying at least one element from the alkali metal or alkaline earth metal on a carrier formed from a porous metal oxide and then carrying a noble metal and at least one element from the 2B and 3B family on the carrier. The produced catalysts can reform hydrocarbon fuel, especially methanol, and can reduce the concentration of carbon monoxide present in the hydrogen-containing gas while maintaining the effects of the noble metal and elements from the 2B and 3B family.

Instep (a) of the second catalyst production method according to the present invention, at least one of cerium dioxide (CeO₂) and zirconium dioxide (ZrO₂) can be used as the carrier and at least one of potassium, magnesium, and calcium can be used as the element from the alkali metal or alkaline earth metal family to be carried on the carrier.

In the second catalyst production method of the present invention, in step (b), at least one of platinum and palladium can be used as the noble metal to be carried on the carrier and at least one of zinc, gallium, and indium can be used as the element from the 2B and 3B family to be carried on the carrier.

As a third catalyst of the present invention, a noble metal and alkali metal are carried on a carrier formed from a basic metal oxide.

In the third catalyst of the present invention, noble metal can act alone as a catalyst to reform hydrocarbon fuel, especially methanol, but, by using the basic metal oxide as the carrier and by carrying an alkali metal with the noble metal, the hydrocarbon fuel, especially methanol, can be efficiently reformed while the concentration of the carbon monoxide present in the obtained hydrogen-containing gas can be simultaneously reduced.

In the third catalyst according to the present invention, any basic metal oxide can be used, but cerium dioxide (CeO₂) or zirconium dioxide (ZrO₂) are preferable. As the noble metal to be carried on the carrier, any one of platinum, palladium, rhodium, or iridium can be used, but either platinum or palladium are preferable. For alkali metal to be carried on the carrier, it is preferable to use at least one of sodium, potassium, and cesium. The alkali metal will act in desired manner when it is carried on the carrier in an amount of 0.5 to 5.0 weight percent, but it is more preferable to carry them on the carrier in an amount of 0.5 to 1.0 weight percent.

A fourth catalyst according to the present invention is formed by carrying a noble metal and alkaline earth metal on a carrier formed from a basic metal oxide.

In the fourth catalyst of the present invention, the noble metal can act alone as a catalyst for reforming hydrocarbon fuel, especially methanol, but, by using a basic metal oxide as a carrier and carrying alkaline earth metal with the noble metal, hydrocarbon fuel, especially methanol, can be reformed with a high efficiency while the concentration of the carbon monoxide present in the obtained hydrogen-containing gas can be simultaneously reduced.

In the fourth catalyst of the present invention, any basic metal oxides can be used, but cerium dioxide (CeO₂) or zirconium dioxide (ZrO₂) are preferable. As the noble metal to be carried on the carrier, any one of platinum, palladium, rhodium, and iridium can be used, but either platinum or palladium are preferable. As the alkaline earth metal to be carried on the carrier, using at least one of magnesium, calcium, and barium is preferable. The alkaline earth metal will act in a desired manner when carried on the carrier with an amount of 0.5 to 5.0 weight percent, but it is more preferable to carry it on the carrier with an amount of 0.5 to 1.0 weight percent.

A third production method of catalyst according to the present invention comprises the step of (a) carrying a noble metal on a carrier using ammine basic solution containing no chlorine or nitrate ion.

In the third catalyst production method of the present invention, by carrying the noble metal on the carrier using ammine basic solution containing no chlorine ion, chlorine, which can act as a poison, is prevented from entering into the catalyst being produced. By carrying the noble metal on the carrier using ammine basic solution containing no nitrate ion, the catalyst to be produced can carry a noble metal instead of oxides of a noble metal. By carrying the noble metal on the carrier using ammine basic solution containing no chlorine or nitrate ion, a catalyst which does not contain chlorine acting as a poison and which carries noble metal instead of oxides of noble metal can be produced. The result is a catalyst which can perform reforming reaction of hydrocarbon, especially methanol, with a high efficiency.

In the third catalyst production method of the present invention, in step (a), ammine hydroxide salt solution can be used as the ammine basic solution to thereby produce a catalyst using a solution which does not contain any chlorine or nitrate ions. In the third catalyst production method of the present invention, in step (a), at least one of platinum, palladium, rhodium, iridium, and ruthenium can be used as the noble metal. Furthermore, in the third catalyst production method of the present invention, porous metal oxide, basic metal oxide, or at least one of cerium dioxide (CeO₂) and zirconium dioxide (ZrO₂) can be used as the carrier. In this manner, an efficient catalyst for water vapor reforming hydrocarbon fuel, especially methanol can be produced.

BRIEF DESCRIPTION OF THE DRAWING(s)

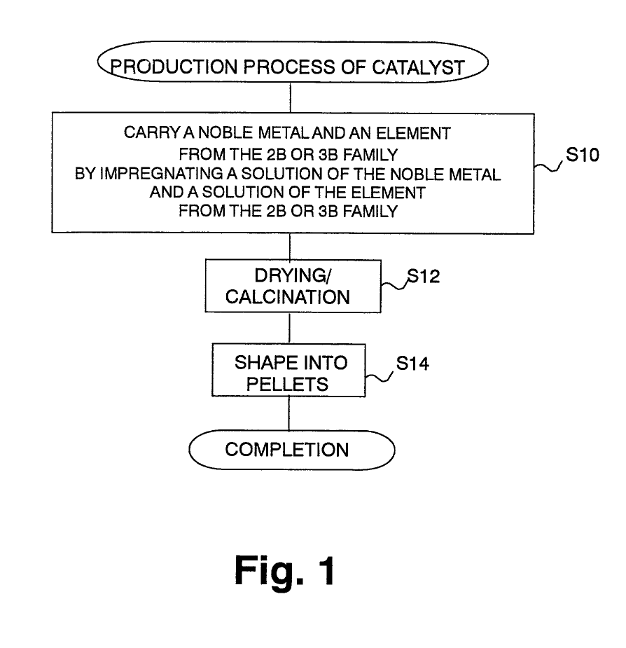

FIG. 1 is a flowchart showing a production process of a catalyst carrying a noble metal and an element from the 2B and 3B family.

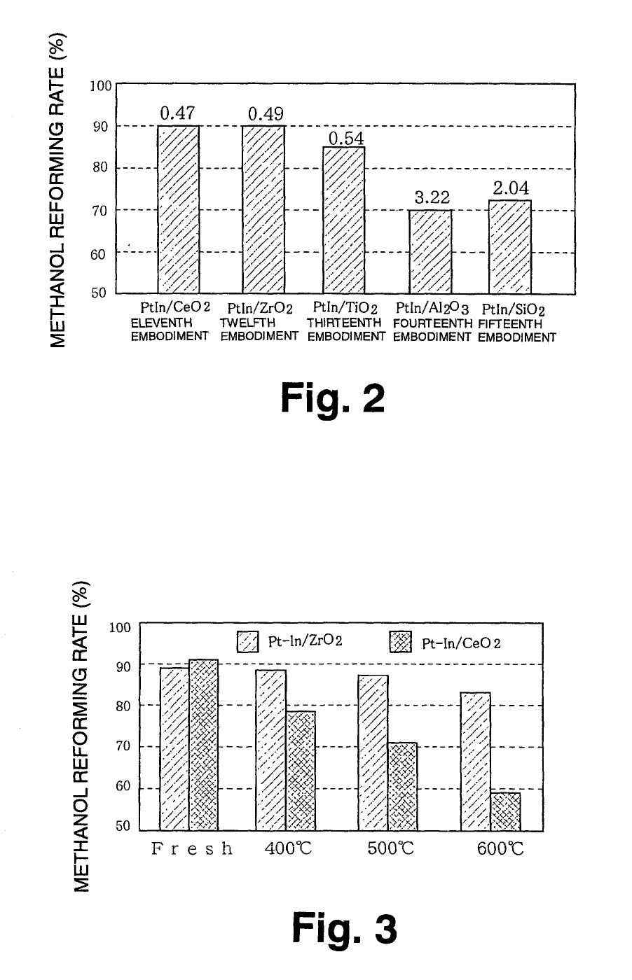

FIG. 2 is a graph showing the methanol reforming rate of a methanol reforming catalyst of the present invention at the beginning of its operation.

FIG. 3 is a graph showing the endurance test results for methanol reforming catalysts of the present invention.

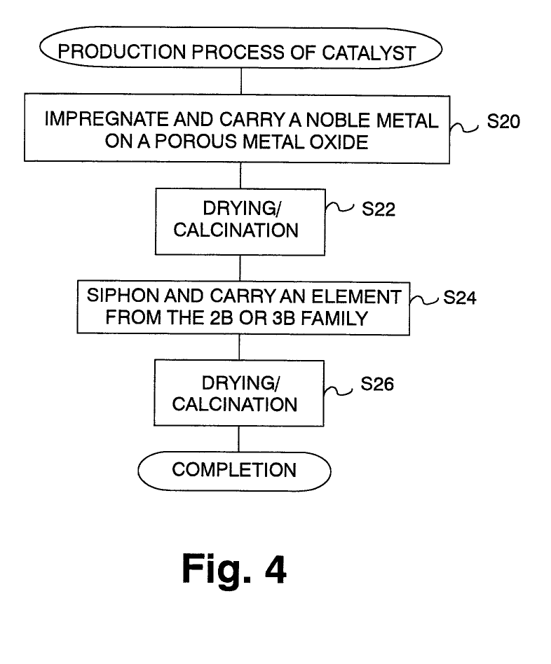

FIG. 4 outlines a production flowchart showing a production process of a catalyst including first impregnating and carrying a noble metal on a porous metal oxide carrier and then siphoning and carrying an element from 2B or 3B family.

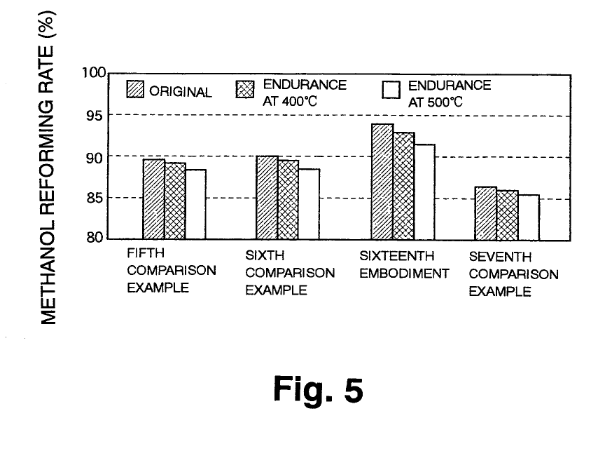

FIG. 5 is a figure showing the original methanol reforming performance and methanol reforming performance in the endurance tests at temperatures of 400° C. and 500° C.

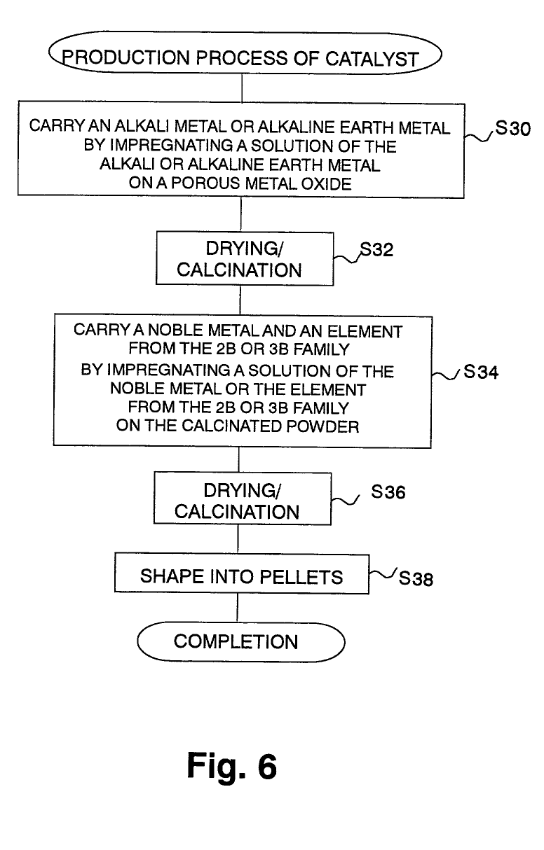

FIG. 6 is a flowchart showing the production process of a catalyst carrying a noble metal, an element from the 2B or 3B family, and an element from the alkali or alkaline earth metal families.

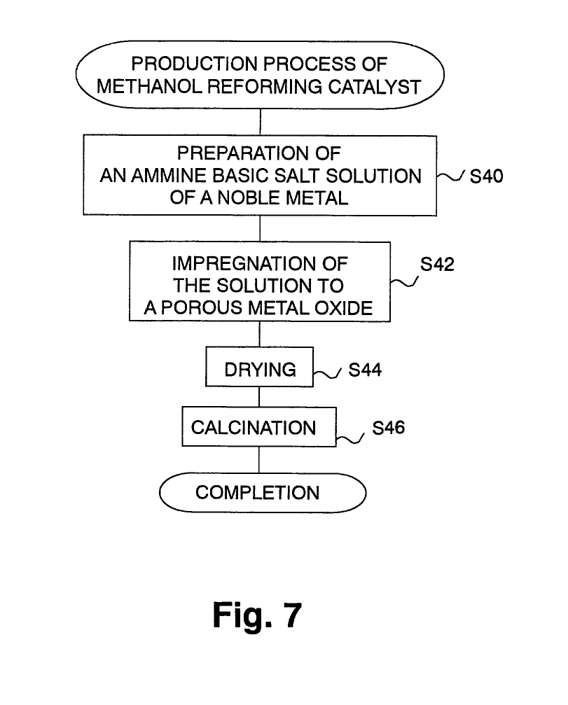

FIG. 7 is a flowchart showing the production of methanol reforming catalyst according to the present invention.

### DESCRIPTION OF THE PREFERRED EMBODIMENTS

Preferred embodiments of the present invention are described in the following.

A. Catalysts carrying a noble metal and an element from the 2B or 3B family

1. Preparation of the methanol reforming catalysts of the embodiments and comparative examples.

The preparation of catalysts carrying a noble metal and an element from the 2B or 3B family is performed according to a catalyst production process shown in FIG. 1. First, a solution of an element from the 2B or 3B family is impregnated to a powder of a carrier formed from a porous metal oxide such as cerium dioxide (CeO₂) or zirconium dioxide (ZrO₂) to carry the noble metal and element from the 2B or 3B family (step S10). Then, the resulting mixture is dried and calcinated (Step S12) and shaped into a predetermined form (S14). Specific examples are described in the following.

Embodiment (1) Methanol Reforming Catalyst

Dinitro diamine platinum nitrate solution and indium nitrate solution were impregnated to 100 g of powder of cerium dioxide (CeO₂) to carry 10 wt % of platinum and indium, respectively. The resulting mixture was dried at a temperature of 110° C. for 3 hours and then calcinated at 500° C. for 1 hour. After calcination, the mixture was placed in a hydrogen reduction atmosphere at 500° C. for 2 hours to perform hydrogen reduction. The powder thus obtained was shaped into pellets having a size of 1 to 3 mm, thereby obtaining the methanol reforming catalyst of a first embodiment of the present invention.

Embodiment (2) Methanol Reforming Catalyst

Dinitro diamine platinum nitrate solution and zinc nitrate solution were impregnated to 100 g of powder of zirconium dioxide (ZrO₂) to carry 10 wt % of platinum and zinc, respectively. The mixture was then dried at a temperature of 110° C. for 3 hours followed by calcination at 500° C. for 1 hour. After calcination, the mixture was placed in a hydrogen reduction atmosphere at 500° C. for 2 hours to perform hydrogen reduction. The powder thus obtained was shaped into pellets having a size of 1 to 3 mm, thereby obtaining the methanol reforming catalyst of a second embodiment.

Embodiment (3) Methanol Reforming Catalyst

Palladium nitrate solution and gallium nitrate solution were impregnated to 100 g of powder of cerium dioxide (CeO₂) to carry 10 wt % of palladium and gallium, respectively. The resulting mixture was then dried at a temperature of 110° C. for 3 hours followed by calcination at 500° C. for 1 hour. After calcination, the mixture was placed in a hydrogen reduction atmosphere at 400° C. for 2 hours to perform hydrogen reduction. The powder thus obtained was shaped into pellets having a size of 1 to 3 mm, thereby obtaining the methanol reforming catalyst of a third embodiment.

Embodiment (4) Methanol Reforming Catalyst

Palladium nitrate solution and indium nitrate solution were impregnated to 100 g of powder of zirconium dioxide (ZrO₂) to carry 10 wt % of palladium and indium, respectively. The resulting mixture was dried at a temperature of 110° C. for 3 hours and then calcinated at 500° C. for 1 hour. After calcination, the mixture was placed in a hydrogen reduction atmosphere at 400° C. for 2 hours to perform hydrogen reduction. The powder thus obtained was shaped into pellets of 1 to 3 mm in size, thereby obtaining the methanol reforming catalyst of a fourth embodiment.

Embodiment (5) Methanol Reforming Catalyst

Dinitro diamine platinum nitrate solution and gallium nitrate solution were impregnated to 100 g of powder of zirconium dioxide (ZrO₂) to carry 10 wt % of platinum and gallium, respectively. The resulting mixture was dried at a temperature of 110° C. for 3 hours and then calcinated at 500° C. for 1 hour. After calcination, the mixture was placed in a hydrogen reduction atmosphere at 500° C. for 2 hours to perform hydrogen reduction. The powder thus obtained was shaped into pellets of 1 to 3 mm in size, thereby obtaining the methanol reforming catalyst of a fifth embodiment.

Embodiment (6) Methanol Reforming Catalyst

Palladium nitrate solution, gallium nitrate solution, and aluminum nitrate solution were impregnated to 100 g of powder of cerium dioxide (CeO₂) to carry 10 wt % of platinum and 5 wt % of gallium and aluminum, respectively. The resulting mixture was dried at a temperature of 110° C. for 3 hours and then calcinated at 500° C. for 1 hour. After calcination, the mixture was placed in a hydrogen reduction atmosphere at 400° C. for 2 hours to perform hydrogen reduction. The powder thus obtained was shaped into pellets of 1 to 3 mm in size, thereby obtaining the methanol reforming catalyst of a sixth embodiment.

Embodiment (7) Methanol Reforming Catalyst

Palladium nitrate solution, indium nitrate solution, and aluminum nitrate solution were impregnated to 100 g of powder of zirconium dioxide (ZrO₂) to carry 10 wt % of palladium and 5 wt % of indium and aluminum, respectively. The resulting mixture was dried at a temperature of 110° C. for 3 hours and then calcinated at 500° C. for 1 hour. After calcination, the mixture was placed in a hydrogen reduction atmosphere at 400° C. for 2 hours to perform hydrogen reduction. The powder thus obtained was shaped into pellets of 1 to 3 mm in size, thereby obtaining the methanol reforming catalyst of a seventh embodiment.

Embodiment (8) Methanol Reforming Catalyst

Dinitro diamine platinum nitrate solution, gallium nitrate solution, and aluminum nitrate solution were impregnated to 100 g of powder of zirconium dioxide (ZrO₂) to carry 10 wt % of platinum and 5 wt % of gallium and aluminum, respectively. The resulting mixture was dried at a temperature of 110° C. for 3 hours and then calcinated at 500° C. for 1 hour. After calcination, the mixture was placed in a hydrogen reduction atmosphere at 500° C. for 2 hours to perform hydrogen reduction. The powder thus obtained was shaped into pellets of 1 to 3 mm in size, thereby obtaining the methanol reforming catalyst of an eighth embodiment of the present invention.

Embodiment (9) Methanol Reforming Catalyst

Dinitro diamine platinum nitrate solution and indium nitrate solution were impregnated to 100 g of powder of cerium dioxide (CeO₂) to carry 10 wt % of platinum and indium, respectively. The resulting mixture was dried at a temperature of 110° C. for 3 hours and then calcinated at 500° C. for 1 hour. The powder thus obtained was shaped into pellets of 1 to 3 mm in size, thereby obtaining the methanol reforming catalyst of a ninth embodiment.

Embodiment (10) Methanol Reforming Catalyst

Dinitro diamine platinum nitrate solution and zinc nitrate solution were impregnated to 100 g of powder of zirconium dioxide (ZrO₂) to carry 10 wt % of platinum and zinc, respectively. The resulting mixture was dried at a temperature of 110° C. for 3 hours and then calcinated at 500° C. for 1 hour. The powder thus obtained was shaped into pellets of 1 to 3 mm in size, thereby obtaining the methanol reforming catalyst of a tenth embodiment.

### Example 1

### Methanol Reforming Catalyst

Dinitro diamine platinum nitrate solution was impregnated to 100 g of powder of cerium dioxide (CeO₂) to carry 10 wt % of platinum. The resulting mixture was dried at a temperature of 110° C. for 3 hours and then calcinated at 500° C. for 1 hour. After calcination, the mixture was placed in a hydrogen reduction atmosphere at 400° C. for 2 hours to perform hydrogen reduction. The powder thus obtained was shaped into pellets of 1 to 3 mm in size, thereby obtaining the methanol reforming catalyst of a first comparative example.

### Example 2

### Methanol Reforming Catalyst

Dinitro diamine platinum nitrate solution was impregnated to 100 g of powder of zirconium dioxide (ZrO₂) to carry 10 wt % of platinum. The resulting mixture was dried at a temperature of 110° C. for 3 hours and then calcinated at 500° C. for 1 hour. After calcination, the mixture was placed in a hydrogen reduction atmosphere at 400° C. for 2 hours to perform hydrogen reduction. The powder thus obtained was shaped into pellets of 1 to 3 mm in size, thereby obtaining the methanol reforming catalyst of a second comparative example.

### Example 3

### Methanol Reforming Catalyst

Palladium nitrate solution was impregnated to 100 g of powder of cerium dioxide (CeO₂) to carry 10 wt % of palladium. The resulting mixture was dried at a temperature of 110° C. for 3 hours and then calcinated at 500° C. for 1 hour. After calcination, the mixture was placed in a hydrogen reduction atmosphere at 400° C. for 2 hours to perform hydrogen reduction. The powder thus obtained was shaped into pellets of 1 to 3 mm in size, thereby obtaining the methanol reforming catalyst of a third comparative example.

### Example 4

### Methanol Reforming Catalyst

Palladium nitrate solution was impregnated to 100 g of powder of zirconium dioxide (ZrO₂) to carry 10 wt % of palladium. The resulting mixture was dried at a temperature of 110° C. for 3 hours and then calcinated at 500° C. for 1 hour. After calcination, the mixture was placed in a hydrogen reduction atmosphere at 400° C. for 2 hours to perform hydrogen reduction. The powder thus obtained was shaped into pellets of 1 to 3 mm in size, thereby obtaining the methanol reforming catalyst of a fourth comparative example.

2. Evaluation method and experimental result

For the methanol reforming catalysts according to the first through the tenth embodiments and the methanol reforming catalysts of the first to fourth comparative examples, a gas mixture was prepared having a molar ratio of water to methanol (H₂O/CH₃OH) of 2.0 and a ratio of the number of oxygen atoms to the number of carbon atoms in methanol (O/C) of 0.23. Methanol was water vapor reformed in a condition where the liquid space velocity (LHSV) of this mixture gas with respect to the methanol was 2 [1/h], the temperature of the mixture gas at the entrance of the reforming reaction layer was 300° C., and the temperature of the gas at the exit was 250° C. The result is shown on the following table 1. In table 1, the methanol reforming rate is the percentage of the methanol reformed by the reforming reaction at the reaction layer and CO selecting rate is the ratio of the amount of generated carbon monoxide with respect to the sum of amount of generated carbon monoxide and the amount of generated carbon dioxide [generated amount of CO/(generated amount of CO+generated amount of CO₂)].

TABLE 1

| | | | METHANOL | CO |
|---|---|---|---|---|
| | | | REFORMING | SELECTING |
| | CARRIER | METAL | RATE(%) | RATE(%) |
| FIRST | CeO₂ | Pt, In | 94 | 4.0 |
| EMBODIMENT | | | | |
| SECOND | ZrO₂ | Pt, Zn | 93 | 6.3 |
| EMBODIMENT | | | | |
| THIRD | CeO₂ | Pd, Ga | 92 | 5.2 |
| EMBODIMENT | | | | |
| FOURTH | ZrO₂ | Pd, In | 93 | 4.8 |
| EMBODIMENT | | | | |
| FIFTH | ZrO₂ | Pt, Ga | 91 | 5.5 |
| EMBODIMENT | | | | |
| SIXTH | CeO₂ | Pd, Ga, Al | 95 | 6.0 |
| EMBODIMENT | | | | |
| SEVENTH | ZrO₂ | Pd, In, Al | 93 | 4.7 |
| EMBODIMENT | | | | |
| EIGHTH | ZrO₂ | Pt, Ga, Al | 92 | 5.0 |
| EMBODIMENT | | | | |
| NINTH | CeO₂ | Pt, In | 96 | 3.8 |
| EMBODIMENT | | | | |
| TENTH | ZrO₂ | Pt, Zn | 92 | 4.5 |
| EMBODIMENT | | | | |
| FIRST EXAMPLE | CeO₂ | Pt | 90 | 12 |
| SECOND EXAMPLE | ZrO₂ | Pt | 94 | 15 |
| THIRD EXAMPLE | CeO₂ | Pd | 93 | 25 |
| FOURTH EXAMPLE | ZrO₂ | Pd | 91 | 27 |

As can be seen from Table 1, the methanol reforming catalysts of the first to the tenth embodiments have high methanol reforming rate similar to those of the catalysts of the first to the fourth comparative examples, but have significantly lower CO selecting rate compared to the catalysts of the first to the fourth comparative examples. Thus, the methanol reforming catalysts of the first through tenth embodiments, by carrying a noble metal and an element from the 2B or 3B family, can perform the water vapor reforming reaction of methanol with a high efficiency while simultaneously maintaining the concentration of carbon monoxide within the obtained hydrogen-containing gas at a low level.

No significant differences can be found in comparisons of the methanol reforming catalysts of the first and the second embodiments with the methanol reforming catalysts of the ninth and tenth embodiments. Therefore, it can be assumed that the hydrogen reduction under the hydrogen reduction atmosphere after the calcination does not influence the ability of the catalysts to act as a methanol reforming catalyst.

3. Comparisons among carrier elements, noble metals, and elements from the 2B or 3B family

This section shows that, among the catalysts formed by carrying a noble metal and an element from the 2B or 3B family on a carrier formed from a porous metal oxides, use of a catalyst which uses zirconium dioxide (ZrO₂) as the carrier of a porous metal oxide, platinum as the noble metal, and indium as the element from the 2B or 3B family is advantageous. The used methanol reforming catalysts of the embodiments were prepared in the following manner.

(1) Preparation of the methanol reforming catalysts of the embodiments

The methanol reforming catalysts of the eleventh to the fifteenth embodiments were prepared using cerium dioxide (CeO₂), zirconium dioxide (ZrO₂), titanium dioxide (TiO₂), aluminum oxide (Al₂O₃), and silicon dioxide (SiO₂) respectively as the porous metal oxides, platinum as the noble metal, and indium as the element from the 2B or 3B family.

The catalyst of the eleventh embodiment was obtained by first coating slurry of 240 g/l cerium dioxide (CeO₂) on a cordurite monolith carrier, drying the resulting mixture at a temperature of 110° C. for 1 hour, and calcinating at 300° C. for 1 hour to obtain a carrier. Indium nitrate solution was siphoned to this carrier to carry indium with an amount of 30 g/l. The resulting material was dried and calcinated. Dinitro diamine platinum nitrate solution was siphoned to the calcinated mixture to carry platinum with an amount of 30 g/l. This was then dried at 110° C. for 3 hours and calcinated at 300° C. for 1 hour.

The methanol reforming catalysts of the twelfth to the fifteenth embodiments were similarly prepared as the methanol reforming catalyst of the eleventh embodiment, with the exception that slurries of zirconium dioxide (ZrO₂), titanium dioxide (TiO₂), aluminum oxide (Al₂O₃), and silicon dioxide (SiO₂) were used for coating the monolith carrier in place of cerium dioxide (CeO₂) as in the eleventh embodiment.

(2) Evaluation method and experimental result

For the methanol reforming catalysts according to the eleventh through the fifteenth embodiments, a mixture gas was prepared having a molar ratio of water to methanol (H₂O/CH₃OH) of 2.0 and a ratio of the number of oxygen atoms to the number of carbon atoms in methanol (O/C) of 0.21. Methanol was water vapor reformed in a condition where the liquid space velocity (LHSV) of this mixture was 2 [1/h], the temperature of the mixture gas at the entrance to the reforming reaction layer was 250° C. and the temperature of the gas at the exit was 250° C. The result is shown in the graph in FIG. 2. The values shown in the figure indicates the emission concentration of carbon monoxide. As shown in the figure, the methanol reforming catalysts of the eleventh to the thirteenth embodiment, respectively using cerium dioxide (CeO₂), zirconium dioxide (ZrO₂), and titanium dioxide (TiO₂) as the porous metal oxide, show better methanol reforming rate than the methanol reforming catalysts of the fourteenth and fifteenth embodiments, respectively using aluminum oxide (Al₂O₃) and silicon dioxide (SiO₂) as the porous metal oxide. From this result, it can be seen that it is advantageous to use cerium dioxide (CeO₂), zirconium dioxide (ZrO₂), or titanium dioxide (TiO₂) as the porous metal oxide, and of these, especially cerium dioxide (CeO₂) and zirconium dioxide (ZrO₂).

Next, the endurance of the methanol reforming catalysts of the eleventh and twelfth embodiments respectively using cerium dioxide (CeO₂) and zirconium dioxide (ZrO₂) as the porous metal oxide were compared. As an experiment, both methanol reforming catalysts were placed in a hydrogen reducing atmosphere with a mixture gas of hydrogen and nitrogen in a ratio of 1:9 at 400, 500, and 600° C. for 8 hours, and methanol was water vapor reformed with an equivalent experimental condition as the experiment to obtain FIG. 2. The result is shown in FIG. 3. For comparison purpose, graphs representing methanol catalysts which were not placed under the hydrogen reducing atmosphere, that is, the methanol reforming catalysts of the eleventh and twelfth embodiments as shown in FIG. 2, are shown in FIG. 3 as “Fresh”. It can be seen from the graph of FIG. 3 that the methanol reforming catalyst of the twelfth embodiment using zirconium dioxide (ZrO₂) as the porous metal oxide has higher endurance than the methanol reforming catalyst of the eleventh embodiment using cerium dioxide (CeO₂).

From these experiments, it can be seen that a methanol reforming catalyst using zirconium dioxide (ZrO₂) as the porous metal oxide, platinum as the noble metal, and indium as the element from the 2B or 3B family is particularly advantageous.

The methanol reforming catalysts in the first to the fifteenth embodiments were used as a catalyst for reforming methanol using water vapor, but they can also be used for reforming hydrocarbon fuels other than methanol (methane, for example).

4. Comparison among production methods

Here, the advantages of a methanol reforming catalyst produced by impregnating and carrying a noble metal on a porous metal oxide carrier and then siphoning and carrying an element from the 2B or 3B family are discussed.

(1) Preparation of methanol reforming catalysts of the embodiments and comparative examples

FIG. 4 is a production flowchart showing the production process of the catalysts of the embodiments. The methanol reforming catalysts of the embodiments were produced by first impregnating and carrying a noble metal such as platinum and palladium on a porous metal oxide carrier such as cerium dioxide (CeO₂), zirconium dioxide (ZrO₂), titanium dioxide (TiO₂), aluminum oxide (Al₂O₃), and silicon dioxide (SiO₂) (step S20). The carrier carrying the noble metal was then dried and calcinated (step S22). An element from the 2B or 3B family such as zinc, gallium, and indium was siphoned and carried on the calcinated carrier (step S24). The carrier was then dried and calcinated (step S26) to yield the methanol reforming catalyst.

Embodiment (16)

The catalyst of the sixteenth embodiment was prepared by first coating slurry of 240 g/l zirconium dioxide (ZrO₂) on a cordurite monolith carrier, drying the resulting mixture at a temperature of 110° C. for 3 hours, and calcinating at 300° C. for 1 hour to obtain a carrier. Dinitro diamine platinum nitrate solution was impregnated to this carrier to carry platinum with an amount of 30 g/l. The resulting material was dried at 110° C. for 3 hours and calcinated at 300° C. for 1 hour. Indium nitrate solution was siphoned to the calcinated mixture to carry indium with an amount of 30 g/l. This was then dried at 110° C. for 3 hours and calcinated at 300° C. for 1 hour.

### Example 5

For comparison, a methanol reforming catalyst of a fifth comparative example was prepared by first preparing a carrier in similar manner. Indium nitrate solution was siphoned to the obtained carrier to carry indium with an amount of 30 g/l. This was then dried at 110° C. for 3 hours and calcinated at 300° C. for 1 hour. Dinitro diamine platinum nitrate solution was siphoned to carry platinum with an amount of 30 g/l. This was then dried at 110° C. for 3 hours and calcinated at 300° C. for 1 hour.

### Example 6

A methanol reforming catalyst of a sixth comparative example was prepared by first preparing a carrier in similar manner. Indium nitrate solution was siphoned to the obtained carrier to carry indium with an amount of 30 g/l. This was then dried at 110° C. for 3 hours and calcinated at 300° C. for 1 hour. Dinitro diamine platinum nitrate solution was impregnated to carry platinum with an amount of 30 g/l. This was then dried at 110° C. for 3 hours and calcinated at 300° C. for 1 hour.

### Example 7

A methanol reforming catalyst of a seventh comparative example was prepared by first preparing a carrier in similar manner. Dinitro diamine platinum nitrate solution was siphoned to the obtained carrier to carry platinum with an amount of 30 g/l. This was then dried at 110° C. for 3 hours and calcinated at 300° C. for 1 hour. Indium nitrate solution was siphoned to carry indium with an amount of 30 g/l. This was then dried at 110° C. for 3 hours and calcinated at 300° C. for 1 hour.

(2) Evaluation method and experimental results

For the methanol reforming catalysts according to the sixteenth embodiment and according to the fifth through seventh comparative examples, a mixture gas was prepared having a molar ratio of water to methanol (H₂O/CH₃OH) of 2.0 and a ratio of the number of oxygen atoms to the number of carbon atoms in methanol (O/C) of 0.21. Methanol was water vapor reformed in a condition where the liquid space velocity (LHSV) of this mixture was 2 [1/h] with respect to methanol, the temperature of the mixture gas at the entrance to the reforming reaction layer was 250° C. and the temperature of the gas at the exit was 250° C. The result is shown in table 2 and FIG. 5. FIG. 5 is a figure showing the original methanol reforming performance and methanol reforming performance in the endurance tests at temperatures of 400° C. and 500° C. The methanol reforming rate is the ratio of methanol which underwent the reforming reaction.

TABLE 2

| | CATALYST PREPARATION | Pt PARTICLE |
|---|---|---|
| | METHOD | SIZE (nm) |
| SIXTEENTH | Impregnate and carry Pt and | 5.2 |
| EMBODIMENT | then siphon and carry In | |
| FIFTH EXAMPLE | Siphon and carry In and then | 7.4 |
| | siphon and carry Pt | |
| SIXTH EXAMPLE | Siphon and carry In and then | 7.5 |
| | impregnate and carry Pt | |
| SEVENTH EXAMPLE | Siphon and carry Pt and then | 8.2 |
| | siphon and carry In | |

As can be seen from FIG. 5, the methanol reforming catalyst of the sixteenth embodiment shows a better methanol reforming rate than do the methanol reforming catalysts of the fifth through seventh comparative examples. This is due to the fact that the particle size of the platinum carried on the methanol reforming catalyst of the sixteenth embodiment is smaller than those of the fifth through seventh comparative examples, as shown in table 2. Thus, by increasing the distributivity of platinum, the catalyst efficiency is increased, and the methanol reforming rate is improved.

Even though platinum was used as the noble metal and indium was used as the element from the 2B or 3B family in the methanol reforming catalyst of the sixteenth embodiment, another noble metal such as palladium and other elements from the 2B or 3B family such as zinc and gallium may also be used.

B. Catalysts carrying a noble metal, an element from the 2B or 3B family, and an alkali metal or alkaline earth metal element

1. Preparation of the methanol reforming catalysts of the embodiments and of the comparative examples

The catalysts formed by carrying a noble metal, an element from the 2B or 3B family, and an alkali metal or alkaline earth metal element were prepared according to the catalyst production process shown in FIG. 4. First, a solution containing alkali metal or alkaline earth metal element was impregnated to powder acting as a carrier formed from porous metal oxides such as cerium dioxide (CeO₂) and zirconium dioxide (ZrO₂) to carry the alkali or alkaline earth metal element (step S30). The mixture was dried and then calcinated (step S32). A solution of noble metal and an element from the 2B or 3B family were impregnated to the calcinated powder thus obtained to carry the noble metal and the element from the 2B or 3B family (step S34). This mixture was dried, then calcinated (step S36), and was shaped into a predetermined shape (step S38).

The specifics are as follows.

Embodiment (18) Methanol Reforming Catalyst

A solution of potassium nitrate was impregnated to 240 g of powder of cerium dioxide (CeO₂) to carry 0.05 mol of potassium. This was dried at 110° C. for 3 hours and then calcinated at 300° C. for 1 hour. Dinitro diamine platinum nitrate solution and indium nitrate solution were impregnated to the calcinated powder to carry 30 g (corresponding to 1 wt %) of platinum and indium, respectively. The resulting mixture was dried at 110° C. for 3 hours and then calcinated at 500° C. for 1 hour. The powder thus obtained was shaped into pellets of size of 1 to 3 mm to obtain the methanol reforming catalyst of a seventeenth embodiment.

Embodiment (18) Methanol Reforming Catalyst

A solution of calcium nitrate was impregnated to 240 g of powder of zirconium dioxide (ZrO₂) to carry 0.05 mol of calcium. The resulting mixture was dried at 110° C. for 3 hours and then calcinated at 300° C. for 1 hour. Dinitro diamine platinum nitrate solution and indium nitrate solution were impregnated to the calcinated powder to carry 30 g (corresponding to 10 wt %) of platinum and indium, respectively. This mixture was dried at 110° C. for 3 hours and then calcinated at 500° C. for 1 hour. The powder thus obtained was shaped into pellets of size of 1 to 3 mm to obtain the methanol reforming catalyst of an eighteenth embodiment.

Embodiment (19) Methanol Reforming Catalyst

A solution of magnesium nitrate was impregnated to 240 g of powder of zirconium dioxide (ZrO₂) to carry 0.05 mol of magnesium. The resulting mixture was dried at 110° C. for 3 hours and then calcinated at 300° C. for 1 hour. Palladium nitrate solution and zinc nitrate solution were impregnated to the calcinated powder to carry 30 g (corresponding to 10 wt %) of palladium and zinc, respectively. This mixture was dried at 110° C. for 3 hours and then calcinated at 500° C. for 1 hour. The powder thus obtained was shaped into pellets of size of 1 to 3 mm to obtain the methanol reforming catalyst of a nineteenth embodiment.

Embodiment (20) Methanol Reforming Catalyst

A solution of potassium nitrate was impregnated to 240 g of powder of zirconium dioxide (ZrO₂) to carry 0.05 mol of potassium. The resulting mixture was dried at 110° C. for 3 hours and then calcinated at 300° C. for 1 hour. Dinitro diamine platinum nitrate solution and indium nitrate solution were impregnated to the calcinated powder to carry 30 g (corresponding to 10 wt %) of platinum and indium, respectively. This mixture was dried at 110° C. for 3 hours and then calcinated at 500° C. for 1 hour. The powder thus obtained was shaped into pellets of size of 1 to 3 mm to obtain the methanol reforming catalyst of a twentieth embodiment.

Embodiment (21) Methanol Reforming Catalyst

A solution of calcium nitrate was impregnated to 240 g of powder of cerium dioxide (CeO₂) to carry 0.05 mol of calcium. The resulting mixture was dried at 110° C. for 3 hours and then calcinated at 300° C. for 1 hour. Dinitro diamine platinum nitrate solution and gallium nitrate solution were impregnated to the calcinated powder to carry 30 g (corresponding to 10 wt %) of platinum and gallium, respectively. This mixture was dried at 110° C. for 3 hours and then calcinated at 500° C. for 1 hour. The powder thus obtained was shaped into pellets of size of 1 to 3 mm to obtain the methanol reforming catalyst of a twenty-first embodiment.

### Example 8

### Methanol Reforming Catalyst

Dinitro diamine platinum nitrate solution and indium nitrate solution were impregnated to 240 g of powder of cerium dioxide (CeO₂) to carry 30 g (corresponding to 10 wt %) of platinum and indium, respectively. This was dried at 110° C. for 3 hours and then calcinated at 500° C. for 1 hour. The powder thus obtained was shaped into pellets of size of 1 to 3 mm to obtain the methanol reforming catalyst of an eighth comparative example.

### Example 9

### Methanol Reforming Catalyst

Dinitro diamine platinum nitrate solution and indium nitrate solution were impregnated to 240 g of powder of zirconium dioxide (ZrO₂) to carry 30 g (corresponding to 10 wt %) of platinum and indium, respectively. The resulting mixture was dried at 110° C. for 3 hours and then calcinated at 500° C. for 1 hour. The powder thus obtained was shaped into pellets of size of 1 to 3 mm to obtain the methanol reforming catalyst of a ninth comparative example.

### Example 10

### Methanol Reforming Catalyst

Dinitro diamine platinum nitrate solution and indium nitrate solution were impregnated to 240 g of powder of cerium dioxide (CeO₂) to carry 30 g (corresponding to 10 wt %) of platinum and indium, respectively. The resulting mixture was dried at 110° C. for 3 hours and then calcinated at 500° C. for 1 hour. Potassium nitrate solution was impregnated to the calcinated powder to carry 0.05 mol of potassium. The powder thus obtained was dried at 110° C. for 3 hours and then calcinated at 300° C. for 1 hour. The powder thus obtained was shaped into pellets of size of 1 to 3 mm to obtain the methanol reforming catalyst of a tenth comparative example.

### Example 11

### Methanol Reforming Catalyst

Dinitro diamine platinum nitrate solution and indium nitrate solution were impregnated to 240 g of powder of zirconium dioxide (ZrO₂) to carry 30 g (corresponding to 10 wt %) of platinum and indium, respectively. The resulting mixture was dried at 110° C. for 3 hours and then calcinated at 500° C. for 1 hour. Calcium nitrate solution was impregnated to the calcinated powder to carry 0.05 mol of calcium. The powder thus obtained was dried at 110° C. for 3 hours and then calcinated at 300° C. for 1 hour. The powder thus obtained was shaped into pellets of size of 1 to 3 mm to obtain the methanol reforming catalyst of an eleventh comparative example.

2. Evaluation method and experimental results

For the methanol reforming catalysts according to the seventeenth through the twenty-first embodiments and of the eighth to eleventh comparative examples, a mixture gas having a molar ratio of water to methanol (H₂O/CH₃OH) of 2.0 and a ratio of the number of oxygen atoms to the number of carbon atoms in the methanol (O/C) of 0.23 was prepared. Methanol was water vapor reformed in a condition where the liquid space velocity (LHSV) of this mixture gas with respect to the methanol was 2 [1/h] and the temperatures of the mixture gas at the entrance of the reforming reaction layer and at the exit were both 250° C. The result is shown on the following Table 3. In Table 3, the methanol reforming rate is the percentage of the methanol reformed by the reforming reaction at the reaction layer.

TABLE 3

| | | | METHANOL | CO |
|---|---|---|---|---|
| | | | REFORMING | CONCENTRA- |
| | CARRIER | METAL | RATE(%) | TION(%) |
| SEVENTEENTH | CeO₂ | Pt, In, K | 90.0 | 0.36 |
| EMBODIMENT | | | | |
| EIGHTEENTH | ZrO₂ | Pt, In, Ca | 90.8 | 0.28 |
| EMBODIMENT | | | | |
| NINETEENTH | ZrO₂ | Pd, Zn, Mg | 88.5 | 0.39 |
| EMBODIMENT | | | | |
| TWENTIETH | ZrO₂ | Pd, In, K | 90.3 | 0.31 |
| EMBODIMENT | | | | |
| TWENTY-FIRST | CeO₂ | Pt, Ga, Ca | 89.5 | 0.37 |
| EMBODIMENT | | | | |
| EIGHTH EXAMPLE | CeO₂ | Pt, In | 90.3 | 0.47 |
| NINTH EXAMPLE | ZrO₂ | Pt, In | 89.7 | 0.49 |
| TENTH EXAMPLE | CeO₂ | Pt, In, K | 74.3 | 0.40 |
| ELEVENTH EXAMPLE | ZrO₂ | Pt, In, Ca | 85.7 | 0.45 |

As can be seen from table 3, the methanol reforming catalysts of the seventeenth to the twenty-first embodiments have high methanol reforming rates similar to those of the catalysts of the eighth and the ninth comparative examples carrying a noble metal and an element from the 2B or 3B family (catalysts corresponding to the catalysts of the first to the fifteenth embodiments) and have lower CO concentration than the catalysts of the eighth and the ninth comparative examples. Thus, the methanol reforming catalysts of the seventeenth through twenty-first embodiments, by carrying alkali metal or alkaline earth metal in addition to a noble metal and an element from the 2B or 3B family, can perform the water vapor reforming reaction of methanol with a high efficiency while simultaneously maintaining the concentration of carbon monoxide within the obtained hydrogen-containing gas at a low level.

When, on the other hand, alkali metal or alkaline earth metal is carried after the noble metal and the element from the 2B or 3B family are carried, as in the catalysts of the tenth and the eleventh comparative examples, a reduction in the methanol reforming rate is observed even though the catalysts of the examples carry alkali metal or alkaline earth metal in addition to a noble metal and an element from the 2B or 3B family. This can be attributed to the fact that the alkali metal or the alkaline earth metal carried later blocks the functions of the noble metal and the element from the 2B or 3B family as a methanol reforming catalyst. In contrast, when the methanol reforming catalysts are formed by carrying the noble metal and the element from the 2B or 3B family after carrying the alkali metal or alkaline earth metal first, as with the catalysts of the seventeenth to the twenty-first embodiments, a good methanol reforming rate can be provided without blockage of the functions of the noble metal and the element from the 2B or 3B family as a methanol reforming catalyst by the alkali metal or alkaline earth metal, and at the same time, concentration of carbon monoxide contained in the obtained hydrogen-containing gas can be kept at a low level by carrying the alkali metal or alkaline earth metal.

The methanol reforming catalysts in the seventeenth to the twenty-first embodiments were used as catalysts to reform methanol using water vapor, but they can also be used to reform hydrocarbon fuels other than methanol (methane, for example).

C. Catalysts carrying a noble metal and alkali metal on a carrier of basic metal oxides

1. Preparation of the methanol reforming catalysts of the embodiments and comparative examples

Embodiment (22) Methanol Reforming Catalyst

A solution of dinitro diamine platinum nitrate was impregnated to powder of cerium dioxide (CeO₂) to carry 10 wt % of platinum. The resulting mixture was dried at 110° C. for 3 hours and then calcinated at 500° C. for 1 hour. Sodium nitrate solution was impregnated to the powder thus obtained to carry 1 wt % of sodium. This mixture was dried at 110° C. for 3 hours and then calcinated at 500° C. for 1 hour. The powder thus obtained was shaped into pellets of size of 1 to 3 mm to obtain the methanol reforming catalyst of a twenty-second embodiment.

Embodiment (23) Methanol Reforming Catalyst

A solution of dinitro diamine platinum nitrate was impregnated to powder of zirconium dioxide (ZrO₂) to carry 10 wt % of platinum. The resulting mixture was dried at 110° C. for 3 hours and then calcinated at 500° C. for 1 hour. Sodium nitrate solution was impregnated to the powder thus obtained to carry 1 wt % of sodium. This mixture was dried at 110° C. for 3 hours and then calcinated at 500° C. for 1 hour. The powder thus obtained was shaped into pellets of size of 1 to 3 mm to obtain the methanol reforming catalyst of a twenty-third embodiment.

Embodiment (24) Methanol Reforming Catalyst

A solution of palladium nitrate was impregnated to powder of cerium dioxide (CeO₂) to carry 10 wt % of palladium. The resulting mixture was dried at 110° C. for 3 hours and then calcinated at 500° C. for 1 hour. Sodium nitrate solution was impregnated to the powder thus obtained to carry 1 wt % of sodium. This mixture was dried at 110° C. for 3 hours and then calcinated at 500° C. for 1 hour. The powder thus obtained was shaped into pellets of size of 1 to 3 mm to obtain the methanol reforming catalyst of a twenty-fourth embodiment.

Embodiment (25) Methanol Reforming Catalyst

A solution of palladium nitrate was impregnated to powder of zirconium dioxide (ZrO₂) to carry 10 wt % of palladium. The resulting mixture was dried at 110° C. for 3 hours and then calcinated at 500° C. for 1 hour. Sodium nitrate solution was impregnated to the powder thus obtained to carry 1 wt % of sodium. This mixture was dried at 110° C. for 3 hours and then calcinated at 500° C. for 1 hour. The powder thus obtained was shaped into pellets of size of 1 to 3 mm to obtain the methanol reforming catalyst of a twenty-fifth embodiment.

Embodiment (26) Methanol Reforming Catalyst

A solution of dinitro diamine platinum nitrate was impregnated to powder of cerium dioxide (CeO₂) to carry 10 wt % of platinum. The resulting mixture was dried at 110° C. for 3 hours and then calcinated at 500° C. for 1 hour. Potassium nitrate solution was impregnated to the powder thus obtained to carry 1 wt % of potassium. This mixture was dried at 110° C. for 3 hours and then calcinated at 500° C. for 1 hour. The powder thus obtained was shaped into pellets of size of 1 to 3 mm to obtain the methanol reforming catalyst of a twenty-sixth embodiment.

Embodiment (27) Methanol Reforming Catalyst

A solution of dinitro diamine platinum nitrate was impregnated to powder of zirconium dioxide (ZrO₂) to carry 10 wt % of platinum. The resulting mixture was dried at 110° C. for 3 hours and then calcinated at 500° C. for 1 hour. Potassium nitrate solution was impregnated to the powder thus obtained to carry 1 wt % of potassium. This mixture was dried at 110° C. for 3 hours and then calcinated at 500° C. for 1 hour. The powder thus obtained was shaped into pellets of size of 1 to 3 mm to obtain the methanol reforming catalyst of a twenty-seventh embodiment.

Embodiment (28) Methanol Reforming catalyst

A solution of palladium nitrate was impregnated to powder of cerium dioxide (CeO₂) to carry 10 wt % of palladium. The resulting mixture was dried at 110° C. for 3 hours and then calcinated at 500° C. for 1 hour. Potassium nitrate solution was impregnated to the powder thus obtained to carry 1 wt % of potassium. This mixture was dried at 110° C. for 3 hours and then calcinated at 500° C. for 1 hour. The powder thus obtained was shaped into pellets of size of 1 to 3 mm to obtain the methanol reforming catalyst of a twenty-eighth embodiment.

Embodiment (29) Methanol Reforming Catalyst

A solution of palladium nitrate was impregnated to powder of zirconium dioxide (ZrO₂) to carry 10 wt % of palladium. The resulting mixture was dried at 110° C. for 3 hours and then calcinated at 500° C. for 1 hour. Potassium nitrate solution was impregnated to the powder thus obtained to carry 1 wt % of potassium. This mixture was dried at 110° C. for 3 hours and then calcinated at 500° C. for 1 hour. The powder thus obtained was shaped into pellets of size of 1 to 3 mm to obtain the methanol reforming catalyst of a twenty-ninth embodiment.

Embodiment (30) Methanol Reforming Catalyst

A solution of dinitro diamine platinum nitrate was impregnated to powder of cerium dioxide (CeO₂) to carry 10 wt % of platinum. The resulting mixture was dried at 110° C. for 3 hours and then calcinated at 500° C. for 1 hour. Cesium nitrate solution was impregnated to the powder thus obtained to carry 1 wt % of cesium. This mixture was dried at 110° C. for 3 hours and then calcinated at 500° C. for 1 hour. The powder thus obtained was shaped into pellets with a size of 1 to 3 mm to obtain the methanol reforming catalyst of a thirtieth embodiment.

Embodiment (31) Methanol Reforming Catalyst

A solution of dinitro diamine platinum nitrate was impregnated to powder of zirconium dioxide (ZrO₂) to carry 10 wt % of platinum. The resulting mixture was dried at 110° C. for 3 hours and then calcinated at 500° C. for 1 hour. Cesium nitrate solution was impregnated to the powder thus obtained to carry 1 wt % of cesium. This mixture was dried at 110° C. for 3 hours and then calcinated at 500° C. for 1 hour. The powder thus obtained was shaped into pellets having a size of 1 to 3 mm to obtain the methanol reforming catalyst of a thirty-first embodiment.

Embodiment (32) Methanol Reforming Catalyst

A solution of palladium nitrate was impregnated to powder of cerium dioxide (CeO₂) to carry 10 wt % of palladium. The resulting mixture was dried at 110° C. for 3 hours and then calcinated at 500° C. for 1 hour. Cesium nitrate solution was impregnated to the powder thus obtained to carry 1 wt % of cesium. This mixture was dried at 110° C. for 3 hours and then calcinated at 500° C. for 1 hour. The powder thus obtained was shaped into pellets of size of 1 to 3 mm to obtain the methanol reforming catalyst of a thirty-second embodiment.

Embodiment (33) Methanol Reforming Catalyst

A solution of palladium nitrate was impregnated to powder of zirconium dioxide (ZrO₂) to carry 10 wt % of palladium. The resulting mixture was dried at 110° C. for 3 hours and then calcinated at 500° C. for 1 hour. Cesium nitrate solution was impregnated to the powder thus obtained to carry 1 wt % of cesium. This mixture was dried at 110° C. for 3 hours and then calcinated at 500° C. for 1 hour. The powder thus obtained was shaped into pellets of size of 1 to 3 mm to obtain the methanol reforming catalyst of a thirty-third embodiment.

Embodiment (34) Methanol Reforming Catalyst

A solution of dinitro diamine platinum nitrate was impregnated to powder of cerium dioxide (CeO₂) to carry 10 wt % of platinum. The resulting mixture was dried at 110° C. for 3 hours and then calcinated at 500° C. for 1 hour. A magnesium nitrate solution was impregnated to the powder thus obtained to carry 1 wt % of magnesium. This mixture was dried at 110° C. for 3 hours and then calcinated at 500° C. for 1 hour. The powder thus obtained was shaped into pellets of size of 1 to 3 mm to obtain the methanol reforming catalyst of a thirty-fourth embodiment.

Embodiment (35) Methanol Reforming Catalyst

A solution of dinitro diamine platinum nitrate was impregnated to powder of zirconium dioxide (ZrO₂) to carry 10 wt % of platinum. The resulting mixture was dried at 110° C. for 3 hours and then calcinated at 500° C. for 1 hour. Calcium nitrate solution was impregnated to the powder thus obtained to carry 1 wt % of calcium. This mixture was dried at 110° C. for 3 hours and then calcinated at 500° C. for 1 hour. The powder thus obtained was shaped into pellets of size of 1 to 3 mm to obtain the methanol reforming catalyst of a thirty-fifth embodiment.

Example (12) Methanol Reforming Catalyst

A solution of dinitro diamine platinum nitrate was impregnated to powder of cerium dioxide (CeO₂) to carry 10 wt % of platinum. The resulting mixture was dried at 110° C. for 3 hours and then calcinated at 500° C. for 1 hour. The powder thus obtained was shaped into pellets of size of 1 to 3 mm to obtain the methanol reforming catalyst of a twelfth comparative example.

### Example 13

### Methanol Reforming Catalyst

A solution of dinitro diamine platinum nitrate was impregnated to powder of zirconium dioxide (ZrO₂) to carry 10 wt % of platinum. The resulting mixture was dried at 110° C. for 3 hours and then calcinated at 500° C. for 1 hour. The powder thus obtained was shaped into pellets of size of 1 to 3 mm to obtain the methanol reforming catalyst of a thirteenth comparative example.

### Example 14

### Methanol Reforming Catalyst

A solution of palladium nitrate was impregnated to powder of cerium dioxide (CeO₂) to carry 10 wt % of palladium. The resulting mixture was dried at 110° C. for 3 hours and then calcinated at 500° C. for 1 hour. The powder thus obtained was shaped into pellets of size of 1 to 3 mm to obtain the methanol reforming catalyst of a fourteenth comparative example.

### Example 15

### Methanol Reforming Catalyst

A solution of palladium nitrate was impregnated to powder of zirconium dioxide (ZrO₂) to carry 10 wt % of palladium. The resulting mixture was dried at 110° C. for 3 hours and then calcinated at 500° C. for 1 hour. The powder thus obtained was shaped into pellets of size of 1 to 3 mm to obtain the methanol reforming catalyst of a fifteenth comparative example.

### Example 16

### Methanol Reforming Catalyst

A solution of dinitro diamine platinum nitrate was impregnated to powder of alumina (Al₂O₃)to carry 10 wt % of platinum. The resulting mixture was dried at 110° C. for 3 hours and then calcinated at 500° C. for 1 hour. Potassium nitrate solution was impregnated to the powder thus obtained to carry 1 wt % of potassium. This mixture was dried at 110° C. for 3 hours and then calcinated at 500° C. for 1 hour. The powder thus obtained was shaped into pellets of size of 1 to 3 mm to obtain the methanol reforming catalyst of a sixteenth comparative example.

2. Evaluation method and experimental result

For the methanol reforming catalysts according to the twenty-second through the thirty-fifth embodiments and the methanol reforming catalysts of the twelfth to sixteenth comparative examples, a mixture gas having a molar ratio of water to methanol (H₂O/CH₃OH) of 2.0 and a ratio of the number of oxygen atoms to the number of carbon atoms in the methanol (O/C) of 0.23 was prepared. Methanol was water vapor reformed at a condition where the liquid space velocity (LHSV) of this mixture gas with respect to the methanol was 2 [1/h], the temperature of the mixture gas at the entrance of the reforming reaction layer was 300° C., and the temperature of the gas at the exit was 250° C. The results are shown on the following Table 4. In Table 4, the methanol conversion rate represents the percentage of the methanol reformed by the reforming reaction at the reaction layer and CO selecting rate represents the ratio of the amount of generated carbon monoxide with respect to the sum of the amount of generated carbon monoxide and the amount of generated carbon dioxide [generated amount of CO/(generated amount of CO+generated amount of CO₂)].

TABLE 4

| | | | METHANOL | CO |
|---|---|---|---|---|
| | | | CONVERSION | SELECTING |
| | CARRIER | METAL | RATE(%) | RATE(%) |
| TWENTY-SECOND | CeO₂ | Pt, Na | 95 | 10 |
| EMBODIMENT | | | | |
| TWENTY-THIRD | ZrO₂ | Pt, Na | 93 | 13 |
| EMBODIMENT | | | | |
| TWENTY-FOURTH | CeO₂ | Pd, Na | 92 | 12 |
| EMBODIMENT | | | | |
| TWENTY-FIFTH | ZrO₂ | Pd, Na | 91 | 11 |
| EMBODIMENT | | | | |
| TWENTY-SIXTH | CeO₂ | Pt, K | 93 | 13 |
| EMBODIMENT | | | | |
| TWENTY-SEVENTH | ZrO₂ | Pt, K | 92 | 12 |
| EMBODIMENT | | | | |
| TWENTY-EIGHTH | CeO₂ | Pd, K | 95 | 14 |
| EMBODIMENT | | | | |
| TWENTY-NINTH | ZrO₂ | Pd, K | 92 | 12 |
| EMBODIMENT | | | | |
| THIRTIETH | CeO₂ | Pt, Cs | 93 | 13 |
| EMBODIMENT | | | | |
| THIRTY-FIRST | ZrO₂ | Pt, Cs | 92 | 12 |
| EMBODIMENT | | | | |
| THIRTY-SECOND | CeO₂ | Pd, Cs | 94 | 14 |
| EMBODIMENT | | | | |
| THIRTY-THIRD | ZrO₂ | Pd, Cs | 95 | 15 |
| EMBODIMENT | | | | |
| THIRTY-FOURTH | CeO₂ | Pt, Mg | 90 | 19 |
| EMBODIMENT | | | | |
| THIRTY-FIFTH | ZrO₂ | Pt, Ca | 89 | 18 |
| EMBODIMENT | | | | |
| TWELFTH EXAMPLE | CeO₂ | Pt | 92 | 32 |
| THIRTEENTH EXAMPLE | ZrO₂ | Pt | 93 | 33 |
| FOURTEENTH EXAMPLE | CeO₂ | Pd | 92 | 32 |
| FIFTEENTH EXAMPLE | ZrO₂ | Pd | 94 | 34 |
| SIXTEENTH EXAMPLE | Al₂o₃ | Pt, K | 88 | 24 |

As can be seen from Table 4, the methanol reforming catalysts of the twenty-second through thirty-fifth embodiments have high methanol conversion rate similar to those of the catalysts of the twelfth to the sixteenth comparative example, but have notably lower CO selecting rate compared to the catalysts of the twelfth to the sixteenth comparative examples. Thus, the methanol reforming catalysts of the twenty-second to the thirty-fifth embodiments can perform the water vapor reforming reaction of methanol with a high efficiency while simultaneously maintaining the concentration of carbon monoxide within the obtained hydrogen-containing gas at a low level. The methanol reforming catalysts of the twenty second to the thirty third embodiments have higher methanol conversion rate than the methanol reforming catalysts of the thirty-fourth and thirty-fifth embodiments and have lower CO selecting rate. Thus, catalysts carrying a noble metal and an alkali metal can perform the water vapor reforming reaction of methanol and maintain the concentration of carbon monoxide in the obtained hydrogen-containing gas at a low level with higher efficiency than the catalysts carrying a noble metal and an alkaline earth metal. As can be seen from a comparison of the methanol reforming catalysts of the twenty-second through twenty-fifth embodiments with the methanol reforming catalyst of the sixteenth comparative example, catalysts using a basic metal oxides such as cerium dioxide and zirconium dioxide as carrier have notably higher methanol conversion rates and lower CO selecting rates than the catalysts using a non-basic metal oxide such as alumina as a carrier. Thus, methanol reforming catalysts using basic methanol oxides such as cerium dioxide and zirconium dioxide as carriers can perform the water vapor reforming reaction of the methanol and keep the concentration of carbon monoxide contained in the obtained hydrogen-containing gas at a low level with higher efficiency than catalysts using a non-basic metal oxides such as alumina as a carrier.

Although the methanol reforming catalysts in the twenty-second through the thirty-fifth embodiments are employed as catalysts to reform methanol using water vapor, they can also be used to reform hydrocarbon fuels other than methanol (methane, for example).

D. Catalysts formed by carrying a noble metal on a carrier using an ammine basic solution containing no chlorine or nitrate ions

As shown in the production flowchart of FIG. 7, The production of methanol reforming catalysts by carrying a noble metal on a carrier using an ammine basic solution containing no chlorine or nitrate ions starts with a process of preparing an ammine basic salt solution of the noble metal (step 40). Next, the ammine basic salt solution of the noble metal prepared in step S40 is impregnated to powder of porous metal oxide which acts as a carrier to carry the noble metal (step 42). Then the carrier with the noble metal carried is dried (step 44) and then calcinated (step 46) to produce a methanol reforming catalyst. Performance of the methanol reforming catalysts produced by this production method is described below.

1. Preparation of methanol reforming catalysts of the embodiments and of the comparative examples

Embodiment (36) Production Method of Methanol Reforming Catalyst

A production method of a methanol reforming catalyst of a thirty-sixth embodiment was performed as follows. As a porous and basic metal oxide carrier, 100 g of cerium dioxide (CeO₂) was prepared. As an ammine basic salt solution of noble metal, a solution of tetra ammine platinum hydroxide [Pt(NH₃)₄(OH)₂] salt was used to carry 10 wt % of platinum on the carrier. The carrier carrying the metal was then dried at 110° C. for 3 hours followed by calcination at 500° C. for 1 hour to produce the methanol reforming catalyst. For comparison purpose, the catalyst thus obtained was shaped into pellets having a size of 1 to 3 mm to be used as the catalyst of the thirty-sixth embodiment.

Embodiment (37) Production Method of Methanol Reforming Catalyst

A production method of a methanol reforming catalyst of a thirty-seventh embodiment was performed as follows. As a porous and basic metal oxide carrier, 100 g of zirconium dioxide (ZrO₂) was used. As an ammine basic salt solution of noble metal, a solution of tetra ammine platinum hydroxide [Pt(NH₃)₄(OH)₂] salt was used to carry 10 wt % of platinum on the carrier. The carrier carrying the metal was then dried at 110° C. for 3 hours followed by calcination at 500° C. for 1 hour to produce the methanol reforming catalyst. For comparison purpose, the catalyst thus obtained was shaped into pellets having a size of 1 to 3 mm to be used as the catalyst of the thirty-seventh embodiment.

Embodiment (38) Production Method of Methanol Reforming Catalyst

A production method of a methanol reforming catalyst of a thirty-eighth embodiment was performed as follows. As a porous and basic metal oxide carrier, 100 g of cerium dioxide (CeO₂) was used. As an ammine basic salt solution of noble metal, a solution of tetra ammine palladium hydroxide [Pd(NH₃)₄( OH)₂] salt was used to carry 10 wt % of palladium on the carrier. The carrier carrying the metal was then dried at 110° C. for 3 hours followed by calcination at 500° C. for 1 hour to produce the methanol reforming catalyst. For comparison purpose, the catalyst thus obtained was shaped into pellets having a size of 1 to 3 mm to be used as the catalyst of the thirty-eighth embodiment.

Embodiment (39) Production Method of Methanol Reforming Catalyst

A production method of a methanol reforming catalyst of a thirty-ninth embodiment was performed as follows. As a porous and basic metal oxide carrier, 100 g of zirconium dioxide (ZrO₂) was used. As an ammine basic salt solution of noble metal, a solution of tetra ammine palladium hydroxide [Pd(NH₃)₄(OH)₂] salt was used to carry 10 wt % of palladium on the carrier. The carrier carrying the metal was then dried at 110° C. for 3 hours followed by calcination at 500° C. for 1 hour to produce the methanol reforming catalyst. For comparison purpose, the catalyst thus obtained was shaped into pellets having a size of 1 to 3 mm to be used as the catalyst of the thirty-ninth embodiment.

Embodiment (40) Production Method of Methanol Reforming Catalyst

A production method of a methanol reforming catalyst of a fortieth embodiment was performed as follows. As a porous and basic metal oxide carrier, 100 g of cerium dioxide (CeO₂) was used. As an ammine basic salt solution of noble metal, a solution of hexa ammine rhodium hydroxide [Rh(NH₃)₆(OH)₃] salt was used to carry 10 wt % of rhodium on the carrier. The carrier carrying the metal was then dried at 110° C. for 3 hours followed by calcination at 500° C. for 1 hour to produce the methanol reforming catalyst. For comparison purpose, the catalyst thus obtained was shaped into pellets having a size of 1 to 3 mm to be used as the catalyst of the fortieth embodiment.

Embodiment (41) Production Method of Methanol Reforming Catalyst

A production method of a methanol reforming catalyst of a forty-first embodiment was performed as follows. As a porous and basic metal oxide carrier, 100 g of zirconium dioxide (ZrO₂) was used. As an ammine basic salt solution of noble metal, a solution of hexa ammine rhodium hydroxide [Rh(NH₃)₆(OH)₃] salt was used to carry 10 wt % of rhodium on the carrier. The carrier carrying the metal was then dried at 110° C. for 3 hours followed by calcination at 500° C. for 1 hour to produce the methanol reforming catalyst. For comparison purpose, the catalyst thus obtained was shaped into pellets having a size of 1 to 3 mm to be used as the catalyst of the forty-first embodiment.

Embodiment (42). Production Method of Methanol Reforming Catalyst

A production method of a methanol reforming catalyst of a forty-second embodiment was performed as follows. As a porous metal oxide carrier, 100 g of alumina (Al₂O₃) was used. As an ammine basic salt solution of noble metal, a solution of tetra ammine palladium hydroxide [Pd(NH₃)₄(OH)₂] salt was used to carry 10 wt % of palladium on the carrier. The carrier carrying the metal was then dried at 110° C. for 3 hours followed by calcination at 500° C. for 1 hour to produce the methanol reforming catalyst. For comparison purpose, the catalyst thus obtained was shaped into pellets having a size of 1 to 3 mm to be used as the catalyst of the forty-second embodiment.

Embodiment (43) Production Method of Methanol Reforming Catalyst

A production method of a methanol reforming catalyst of a forty-third embodiment was performed as follows. As a porous and basic metal oxide carrier, 100 g of cerium dioxide (CeO₂) was used. As an ammine basic salt solution of noble metal, a solution of tetra ammine platinum hydroxide [Pt(NH₃)₄ (OH)₂] salt was used to carry 2 wt % of platinum on the carrier. The carrier carrying the metal was then dried at 110° C. for 3 hours followed by calcination at 500° C. for 1 hour to produce the methanol reforming catalyst. For comparison purpose, the catalyst thus obtained was shaped into pellets having a size of 1 to 3 mm to be used as the catalyst of the forty-third embodiment.

Embodiment (44) Production Method of Methanol Reforming Catalyst

A production method of a methanol reforming catalyst of a forty-fourth embodiment was performed as follows. As a porous metal oxide carrier, 100 g of alumina (Al₂O₃) was used. As an ammine basic salt solution of noble metal, a solution of tetra ammine platinum hydroxide [Pt(NH₃)₄(OH)₂] salt was used to carry 2 wt % of platinum on the carrier. The carrier carrying the metal was then dried at 110° C. for 3 hours followed by calcination at 500° C. for 1 hour to produce the methanol reforming catalyst. For comparison purpose, the catalyst thus obtained was shaped into pellets having a size of 1 to 3 mm to be used as the catalyst of the forty-fourth embodiment.

### Example 17

### Production Method of Methanol Reforming Catalyst

A production method of a methanol reforming catalyst of a seventeenth comparative example was performed as follows. As a porous and basic metal oxide carrier, 100 g of cerium dioxide (CeO₂) was used. As a solution of noble metal, a nitrate solution of dinitro diamine platinum [Pt(NO₂)₂(NH₃)₂] was used to carry 10 wt % of platinum on the carrier. The carrier carrying the metal was then dried at 110° C. for 3 hours followed by calcination at 500° C. for 1 hour to produce the methanol reforming catalyst. For comparison purpose, the catalyst thus obtained was shaped into pellets having a size of 1 to 3 mm to be used as the catalyst of the seventeenth comparative example.

### Example 18

### Production Method of Methanol Reforming Catalyst

A production method of a methanol reforming catalyst of an eighteenth comparative example was performed as follows. As a porous and basic metal oxide carrier, 100 g of zirconium dioxide (ZrO₂) was used. As a solution of noble metal, a nitrate solution of dinitro diamine platinum [Pt(NO₂)₂(NH₃)₂] was used to carry 10 wt % of platinum on the carrier. The carrier carrying the metal was then dried at 110° C. for 3 hours followed by calcination at 500° C. for 1 hour to produce the methanol reforming catalyst. For comparison purpose, the catalyst thus obtained was shaped into pellets having a size of 1 to 3 mm to be used as the catalyst of the eighteenth comparative example.

### Example 19

### Production Method of Methanol Reforming Catalyst

A production method of a methanol reforming catalyst of a nineteenth comparative example was performed as follows. As a porous and basic metal oxide carrier, 100 g of cerium dioxide (CeO₂) was used. As a solution of noble metal, a solution of palladium nitrate [Pd(NO₃)₂] was used to carry 10 wt % of palladium on the carrier. The carrier carrying the metal was then dried at 110° C. for 3 hours followed by calcination at 500° C. for 1 hour to produce the methanol reforming catalyst. For comparison purpose, the catalyst thus obtained was shaped into pellets having a size of 1 to 3 mm to be used as the catalyst of the nineteenth comparative example.

### Example 20

### Production Method of Methanol Reforming Catalyst

A production method of a methanol reforming catalyst of a twentieth comparative example was performed as follows. As a porous and basic metal oxide carrier, 100 g of zirconium dioxide (ZrO₂) was used. As a solution of noble metal, a solution of palladium nitrate [Pd(NO₃)₂] was used to carry 10 wt % of palladium on the carrier. The carrier carrying the metal was then dried at 110° C. for 3 hours followed by calcination at 500° C. for 1 hour to produce the methanol reforming catalyst. For comparison purpose, the catalyst thus obtained was shaped into pellets having a size of 1 to 3 mm to be used as the catalyst of the twentieth comparative example.

### Example 21

### Production Method of Methanol Reforming Catalyst

A production method of a methanol reforming catalyst of a twenty-first comparative example was performed as follows. As a porous and basic metal oxide carrier, 100 g of cerium dioxide (CeO₂) was used. As a solution of noble metal, a solution of rhodium nitrate [Rh(NO₃)₃] was used to carry 10 wt % of rhodium on the carrier. The carrier carrying the metal was then dried at 110° C. for 3 hours followed by calcination at 500° C. for 1 hour to produce the methanol reforming catalyst. For comparison purpose, the catalyst thus obtained was shaped into pellets having a size of 1 to 3 mm to be used as the catalyst of the twenty-first comparative example.

### Example 22

### Production Method of Methanol Reforming Catalyst

A production method of a methanol reforming catalyst of a twenty-second comparative example was performed as follows. As a porous and basic metal oxide carrier, 100 g of cerium dioxide (CeO₂) was used. As an ammine solution of noble metal, a solution of tetra ammine platinum chloride [Pt(NH₃)₄Cl₂] was used to carry 10 wt % of platinum on the carrier. The carrier carrying the metal was then dried at 110° C. for 3 hours followed by calcination at 500° C. for 1 hour to produce the methanol reforming catalyst. For comparison purpose, the catalyst thus obtained was shaped into pellets having a size of 1 to 3 mm to be used as the catalyst of the twenty-second comparative example.

2. Evaluation method and experimental results

For the catalysts produced by the production methods according to the thirty-sixth through the forty-fourth embodiments and the catalysts produced by the production methods of the seventeenth through the twenty-second comparative example, a mixture gas having a molar ratio of water to methanol (H₂O/CHOH) of 2.0 and a ratio of the number of oxygen atoms to the number of carbon atoms in the methanol (O/C) of 0.23 was prepared. With this mixture gas, methanol was water vapor reformed at a condition where the liquid space velocity (LHSV) of this mixture gas with respect to the methanol was 2 [1/h], the temperature of the mixture gas at the entrance of the reforming reaction layer was 300° C., and the temperature of the gas at the exit was 250° C. The result is shown on the following Table 5. In Table 5, the conversion rate represents the percentage of the methanol reformed by the reforming reaction at the reaction layer and CO rate represents the ratio of the amount of generated carbon monoxide with respect to the sum of the amount of generated carbon monoxide and the amount of generated carbon dioxide [generated amount of CO/(generated amount of CO+generated amount of CO₂)].

TABLE 5

| | | | | CONVERSION | CO |
|---|---|---|---|---|---|
| | CARRIER | SOLUTION | METAL | RATE(%) | RATE(%) |
| THIRTY- | CeO₂ | TETRA AMMINE | Pt | 95 | 10 |
| SIXTH | | Pt HYDROXIDE | | | |
| EMBODIMENT | | SALT | | | |
| THIRTY- | ZrO₂ | TETRA AMMINE | Pt | 93 | 12 |
| SEVENTH | | Pt HYDROXIDE | | | |
| EMBODIMENT | | SALT | | | |
| THIRTY- | CeO₂ | TETRA AMMINE | Pd | 92 | 11 |
| EIGHTH | | Pd HYDROXIDE | | | |
| EMBODIMENT | | SALT | | | |
| THIRTY- | ZrO₂ | TETRA AMMINE | Pd | 93 | 13 |
| NINTH | | Pd HYDROXIDE | | | |
| EMBODIMENT | | SALT | | | |
| FORTIETH | CeO₂ | HEXA AMMINE | Rh | 92 | 14 |
| EMBODIMENT | | Rh HYDROXIDE | | | |
| | | SALT | | | |
| FORTY-FIRST | ZrO₂ | HEXA AMMINE | Rh | 95 | 12 |
| EMBODIMENT | | Rh HYDROXIDE | | | |
| | | SALT | | | |
| FORTY- | Al₂O₃ | TETRA AMMINE | Pd | 93 | 13 |
| SECOND | | Pd HYDROXIDE | | | |
| EMBODIMENT | | SALT | | | |
| FORTY-THIRD | CeO₂ | TETRA AMMINE | Pt | 80 | 17 |
| EMBODIMENT | | Pt HYDROXIDE | | | |
| | | SALT | | | |
| FORTY- | Al₂o₃ | TETRA AMMINE | Pt | 71 | 24 |
| FOURTH | | Pt HYDROXIDE | | | |
| EMBODIMENT | | SALT | | | |
| SEVENTEENTH | CeO₂ | DINITRO | Pt | 92 | 34 |
| EXAMPLE | | DIAMMINE Pt | | | |
| | | NITRATE | | | |
| EIGHTEENTH | ZrO₂ | DINITRO | Pt | 94 | 35 |
| EXAMPLE | | DIAMMINE Pt | | | |
| | | NITRATE | | | |
| NINETEENTH | CeO₂ | Pd NITRATE | Pd | 92 | 32 |
| EXAMPLE | | | | | |
| TWENTIETH | ZrO₂ | Pd NITRATE | Pd | 93 | 33 |
| EXAMPLE | | | | | |
| TWENTY- | CeO₂ | Rh NITRATE | Rh | 92 | 34 |
| FIRST | | | | | |
| EXAMPLE | | | | | |
| TWENTY- | CeO₂ | TETRA AMMINE | Pt | 87 | 38 |
| SECOND | | Pt CHLORIDE | | | |
| EXAMPLE | | | | | |

As can be seen from Table 5, the methanol reforming catalysts produced by the production methods of the thirty-sixth through forty-second embodiments have a high methanol conversion rate similar to those of the catalysts produced by the production methods of the seventeenth through twenty-second comparative examples and have significantly lower CO rate compared to the methanol reforming catalysts of each of the comparative examples. It can thus be seen that the methanol reforming catalyst production methods of the thirty-sixth through forty-second embodiments can produce methanol reforming catalysts that can perform the water vapor reforming reaction of methanol with a high efficiency while simultaneously maintaining the concentration of carbon monoxide within the obtained hydrogen-containing gas at a low level.

The methanol reforming catalysts produced by the production method of the forty-third and forty-fourth embodiments carry less noble metal. By comparing the performance of the catalysts produced by these two production methods, it can be seen that the catalysts using a basic metal oxide such as cerium dioxide (CeO₂) and zirconium dioxide (ZrO₂) as a carrier show better performance as a catalyst than the catalysts using a simple porous metal oxide such as alumina. However, even when a simple porous metal oxide is used as a carrier, the catalysts show better performance as a catalyst than the comparative examples if enough amount of noble metal is carried, as can be seen from the tests on the thirty-fifth embodiment.

In the production methods of methanol reforming catalysts according to the thirty-sixth through forty-fourth embodiments, ammine hydroxide salt solution of noble metal was used to carry the noble metal on the carrier, but, for purpose of avoiding catalyst poisoning by chlorine, any ammine basic salt solution of noble metal other than chlorine salt solution containing chlorine ion can be used to carry the noble metal. Also, for the purpose of avoiding oxidation of the noble metal by nitrate ion, any ammine basic solution of noble metal other than nitrate salt solution which contains nitrate ion can be used.

The methanol catalyst production methods of the thirty-sixth through forty-fourth embodiments are described as production methods of catalysts for reforming methanol using water vapor, but the catalysts can also be used to reform hydrocarbon fuels other than methanol (methane, for example) and therefore, the catalyst production methods of each of the embodiments can be considered to be catalyst production methods of catalysts for reforming hydrocarbon fuel.

What is claimed is:

1. A method of reforming a hydrocarbon fuel to a hydrogen containing gas, comprising contacting the hydrocarbon fuel with a catalyst, the catalyst formed by carrying a noble metal and indium on a porous metal oxide carrier.

2. The method according to claim 1, wherein the hydrocarbon fuel is methanol.

3. A method of reforming a hydrocarbon fuel to a hydrogen containing gas, comprising contacting the hydrocarbon fuel with a catalyst, the catalyst formed by:
first carrying at least one element from the alkali metal and alkaline earth metal family on a porous metal oxide carrier, and
then carrying a noble metal and at least one element from the 2B and 3B families, each having a fuel reforming catalytic function, on said carrier,
wherein a blocking of the fuel reforming catalytic functions by carrying an alkali metal or an alkaline earth metal after carrying the noble metal and the at least one element from the 2B and 3B families is prevented by first carrying the at least one element from the alkali metal and alkaline earth metal family on the porous metal oxide carrier.

4. The method according to claim 3, wherein the hydrocarbon fuel is methanol.

5. A method of reforming a hydrocarbon fuel to a hydrogen containing gas, comprising contacting the hydrocarbon fuel with a catalyst, the catalyst formed by carrying a noble metal and an alkali metal on ZrO₂.

6. The method according to claim 5, wherein the hydrocarbon fuel is methanol.

7. A method of reforming a hydrocarbon fuel to a hydrogen containing gas, comprising contacting the hydrocarbon fuel with a catalyst, the catalyst formed by carrying a noble metal and an alkaline earth metal on ZrO₂.

8. The method according to claim 7, wherein the hydrocarbon fuel is methanol.

9. A method of reforming a hydrocarbon fuel to a hydrogen containing gas, comprising contacting the hydrocarbon fuel with a catalyst, the catalyst produced by:
impregnating and carrying a noble metal on a porous metal oxide carrier; and
siphoning and carrying at least one element from the 2B or 3B family on the carrier carrying the noble metal.

10. The method according to claim 9, wherein the hydrocarbon fuel is methanol.

11. A method of reforming a hydrocarbon fuel to a hydrogen containing gas, comprising contacting the hydrocarbon fuel with a catalyst, the catalyst formed by:
carrying at least one element from the alkali metal and alkaline earth metal family on a porous metal oxide carrier; and
carrying a noble metal and at least one element from the 2B and 3B families on the carrier carrying the at least one metal from the alkali metal or alkaline earth metal family.

12. The method according to claim 11, wherein the hydrocarbon fuel is methanol.

13. A method of reforming a hydrocarbon fuel to a hydrogen containing gas, comprising contacting the hydrocarbon fuel with a catalyst, the catalyst formed by carrying a noble metal on a basic metal oxide using an ammine basic solution that does not contain any chlorine or nitrate ions.

14. The method according to claim 13, wherein the hydrocarbon fuel is methanol.
